(19) United States
(12) Patent Application Publication
(10) Pub. No.: US 2011/0293874 A1
(43) Pub. Date: Dec. 1, 2011

(54) HYBRID SUBSTRATE AND METHOD FOR PRODUCING THE SAME

(76) Inventors: Takashi TOYOOKA, Ehime (JP); Hiroshi OKADA, Ehime (JP); Shigetoshi SEGAWA, Ehime (JP); Seiichi NAKATANI, Osaka (JP)

(21) Appl. No.: 13/115,405

(22) Filed: May 25, 2011

(30) Foreign Application Priority Data
May 26, 2010 (JP) 2010-120026

(51) Int. Cl. B32B 3/18; B32B 37/14; B32B 37/06; B32B 37/10; B32B 3/22; B32B 37/02

(52) U.S. Cl. 428/49; 428/47; 156/60

(57) ABSTRACT

The hybrid substrate of the present invention comprises a ceramic substrate assembly composed of a plurality of ceramic substrates, insulating resin layers disposed respectively on both surfaces of the ceramic substrate assembly such that they are opposed to each other, each of the insulating resin layers being made at least of a reinforcing material and a resin, and a metal layer disposed on each of the insulating resin layers. In particular, the hybrid substrate of the present invention comprises the plurality of ceramic substrates which are in the form of a tile arrangement along the same plane positioned between the opposed insulating resin layers.

### TECHNICAL FIELD

The present invention relates to a hybrid substrate and a method for producing the same. In particular, the present invention relates to a hybrid substrate which is mainly composed of a ceramic substrate, an insulating resin layer and a metal layer, and also it relates to a method for producing such hybrid substrate.

### BACKGROUND OF THE INVENTION

A ceramic substrate is excellent in heat resistance and moisture resistance, and it can also exhibit satisfactory frequency characteristics in a high-frequency circuit. Accordingly, the ceramic substrate is used not only as a substrate for a radio frequency (RF) module of a mobile device, and a power light emitting diode (LED) in which heat radiation is considered, but also as a substrate for a LED backlight of a liquid crystal, and also for an in-vehicle electronic control circuit.

Currently, the ceramic substrate has the principal surface size of about 100 mm square, as disclosed in Patent Document described below. In this regard, if the area of one ceramic substrate becomes too large, there will be occurred a larger warp in the substrate upon the production thereof. As such, the existing substrate should measure about 100 mm on each side of the principal surface thereof.

### PATENT DOCUMENT OF PRIOR ART

[Patent document 1] WO 2009/087845

### SUMMARY OF THE INVENTION

### Problems to be Solved by the Invention

A composite substrate is well known where an inorganic material as a main component is provided, and also a printed board whose insulating material is an organic resin is provided. In particular, a build-up substrate is expected to be promising as a next-generation substrate for a high-density mounting, wherein a core substrate made of ceramic is used, and resin insulating layers are stacked respectively on both surfaces of the core substrate. As such, a ceramic substrate can be used for the production of the build-up substrate. There is, however, a difference in size between the ceramic substrate and the build-up substrate. For example, the ceramic substrate has the size of approximately 100 mm×100 mm, whereas a printed board as typified by the build-up substrate has the size of approximately 340 mm×510 mm. Such size difference can adversely affect the production of the build-up substrate. This means that the production of the build-up substrate is significantly affected by the size of the ceramic substrate. As such, there is room for improvement in productivity of the build-up substrate.

Specifically, the ceramic substrate has a small size which is, for example, about 100 mm in its one side, and consequently the production of the build-up substrate is constrained by such small size of the ceramic substrate because the production of the large build-up substrate utilizes the ceramic substrate. As a result, the productivity of the build-up substrate is currently not high enough.

The mere use of a large-sized ceramic substrate may be possible, but it is however difficult to produce a setter plate for the firing of such larged-sized substrate. Even if such setter plate is produced, it will become very expensive, or a high degree of its accuracy will be required in terms of smoothness. Furthermore, the merely large-sized ceramic substrate is associated with a risk of the cracking and chipping of the substrate, making it difficult to covey the substrate without preventing the cracking and the chipping thereof during its production process.

Under the above circumstances, the present invention has been created. That is, a main object of the present invention is to provide a substrate suited for the production of the build-up substrate.

### Means for Solving the Problem

In order to achieve the above object, the present invention provides a hybrid substrate comprising:

a ceramic substrate assembly composed of a plurality of ceramic substrates;

insulating resin layers disposed respectively on both surfaces of the ceramic substrate assembly such that they are opposed to each other, each of the insulating resin layers being made at least of a reinforcing material (e.g., woven fabrics or nonwoven fabrics) and a resin; and

a metal layer disposed on each of the insulating resin layers,

and wherein the plurality of ceramic substrates are in the form of a tile arrangement along the same plane positioned between the opposed insulating resin layers.

The hybrid substrate of the present invention is characterized at least in that the ceramic substrate assembly is laid between the opposed insulating resin layers so that the assembly forms a tile arrangement (planar arrangement). In other words, the hybrid substrate of the present invention comprises the plurality of ceramic substrates which are arranged in a tile form such that they are positioned on the same level to be interposed between the insulating resin layers each of which is made of the reinforcing material and the resin.

As used in the present description and claims, the term hybrid is used in light of the embodiment wherein the substrate of the invention is composed of a plurality of materials (i.e., inorganic material, organic material and metallic material) as typified by components such as a ceramic substrate, an insulating resin layer and a metal layer.

As used in the present description and claims, the term tile or tile arrangement is used in light of the embodiment wherein ceramic substrates are located closer together in the same plane. In particular, the term tile or tile arrangement is used in light of the embodiment wherein a plurality of ceramic substrates are arranged along the same plane between the two opposed insulating resin layers so that they do not mutually overlap.

In one preferred embodiment, the plurality of ceramic substrates are arranged in the tile form such that they are spaced from each other. In this regard, a frame member may be optionally provided between the opposed insulating resin layers wherein the plurality of ceramic substrates are fitted into the frame member, and thereby the tile arrangement is formed.

In another preferred embodiment, the plurality of ceramic substrates are arranged in the tile form such that they are in close contact with each other. That is, the respective side faces of the ceramic substrates are in contact with each other, and thereby the tile arrangement is formed.

In still another preferred embodiment, at least one of the plurality of ceramic substrates has an inner via therein. In this regard, the plurality of ceramic substrates (especially at least two ceramic substrates) may respectively have the inner vias whose configurations are different from each other.

In still another preferred embodiment, at least one of the plurality of ceramic substrates has at least one wiring layer in the interior thereof or on the surface thereof. In this regard, the plurality of ceramic substrates (especially at least two ceramic substrates) may respectively have the wiring layers whose numbers or forms are different from each other.

In still another preferred embodiment, the respective principal surfaces of the plurality of ceramic substrates are flush with each other. In other words, with respect to the plurality of ceramic substrates (i.e., ceramic substrates in the spaced tile arrangement or ceramic substrates in the close-contacted tile arrangement), all the upper principal surfaces are positioned in the same plane and/or all the lower principal surfaces are positioned in the same plane.

The present invention also provides a method for the hybrid substrate as described above. This method of the present invention comprises the steps of:

(i) disposing a first insulating resin layer precursor on a first metal foil;

(ii) disposing a ceramic substrate assembly composed of a plurality of ceramic substrates on the first insulating resin layer precursor;

(iii) disposing a second insulating resin layer precursor on the ceramic substrate assembly, and then disposing a second metal foil on the second insulating resin layer precursor, and thereby forming a hybrid substrate precursor; and

(iv) pressing the hybrid substrate precursor under a heating condition to produce a hybrid substrate, and

wherein, in the step (ii), the plurality of ceramic substrates are disposed in the form of a tile arrangement so that they are laid along the same plane.

The method of the present invention is characterized at least in that the ceramic substrates of the assembly are closely laid along the same plane so that the tile arrangement (planar arrangement) is formed. In other words, the plurality of ceramic substrates to be positioned between insulating resin layer precursors are disposed in the tile form along the same plane.

In one preferred embodiment, the plurality of ceramic substrates are disposed in spaced relation to each other so that the tile arrangement of the ceramic substrates is formed. It is preferred in this regard that a frame member is used when the ceramic substrates are arranged in a tile form. The reason for this is that the plurality of ceramic substrates can be positioned in the spaced relation to each other by fitting them respectively into the hollow portions of the frame member. For example, the frame member is disposed on the first insulating resin layer precursor, and thereafter the respective ones of the ceramic substrates are fitted into a plurality of the hollow portions of the frame member. This can result in the tile arrangement wherein the ceramic substrates are spaced apart by a predetermined interval from each other. Alternatively, the tile arrangement of the ceramic substrates may be formed by disposing the ceramic substrate assembly on the first insulating resin layer precursor, followed by disposing the frame member on the insulating resin layer precursor.

In another preferred embodiment, the plurality of ceramic substrates are disposed in close contact with each other so that the tile arrangement of the ceramic substrates is formed. That is, the ceramic substrates may be arranged in the tile form so that the respective side faces of the ceramic substrates come into contact with each other.

### Effect of the Invention

The hybrid substrate according to the present invention can be handled as a large-sized one since the ceramic substrates of the assembly are integrated with each other. Accordingly, the hybrid substrate of the present invention can contribute to an improvement in the productivity of the build-up substrate.

Specifically, the present invention makes use of the relatively small-sized ceramic substrate in itself, but nevertheless the invention enables a suitable availability of the production facilities for a printed substrate where a build-up substrate is produced. Furthermore, depending on a variety of combinations of the ceramic substrates, there can be obtained the large-sized hybrid substrates with any suitable sizes.

The hybrid substrate of the present invention exhibits a high (bending) strength while being large-sized. The reason for this is that a sufficient integrity of the substrates is achieved as a whole by the use of the reinforcing material (e.g., woven fabrics or nonwoven fabrics). Accordingly, the present invention can provide the large-sized substrate in which the cracking and chipping are prevented.

Furthermore, the hybrid substrate of the present invention, even though being large-sized, can reduce its warp as a whole since a ceramic portion of the substrate is composed of a plurality of sub-substrates (namely, the ceramic portion of the substrate has an individually separated form). In other words, in accordance with the present invention, there can be obtained a large-sized substrate with its warp being effectively prevented.

### BRIEF DESCRIPTION OF THE DRAWINGS

FIG. 1(a) is a sectional view schematically illustrating a hybrid substrate in accordance with an embodiment of the present invention.

FIG. 1(b) is a horizontal sectional view of the hybrid substrate, taken along lines a-a of FIG. 1(a).

FIG. 2 is an exploded perspective view schematically illustrating the structure of the hybrid substrate of FIG. 1.

FIGS. 3(a) to 3(d) are plan views schematically illustrating various kinds of tile arrangement of the ceramic substrates.

FIG. 4(a) is a sectional view schematically illustrating a hybrid substrate in accordance with an embodiment of the present invention.

FIG. 4(b) is a horizontal sectional view of the hybrid substrate, taken along lines a-a of FIG. 4(a).

FIG. 5 is an exploded perspective view schematically illustrating the structure of the hybrid substrate of FIG. 4.

FIG. 6(a) is a plan view schematically illustrating a frame member.

FIG. 6(b) is a sectional view of the frame member, taken along lines a-a of FIG. 6(a).

FIG. 7(a) is a sectional view schematically illustrating a hybrid substrate in which a frame member is used.

FIG. 7(b) is an exploded perspective view schematically illustrating the structure of the hybrid substrate of FIG. 7(a).

FIG. 8(a) is a perspective view schematically illustrating a hybrid substrate in accordance with an embodiment of the present invention.

FIG. 8(b) is a sectional view of the hybrid substrate, taken along lines a-a of FIG. 8(a).

FIG. 9 is a view schematically illustrating a plurality of ceramic substrates respectively having inner vias whose configurations are different from each other, and also respectively having wiring layers whose numbers or forms are different from each other.

FIG. 10 is an exploded perspective view schematically illustrating the structure of a hybrid substrate in which the ceramic substrates of FIG. 9 are used.

FIG. 11 shows a process flow of a production method of the present invention.

FIGS. 12(a) to 12(e) are sectional views illustrating the steps in a producing process of a hybrid substrate in accordance with an embodiment of the present invention (close-contacted tile arrangement).

FIGS. 13(a) to 13(b) are sectional views illustrating the steps in a producing process of a hybrid substrate in accordance with an embodiment of the present invention (close-contacted tile arrangement).

FIG. 14 is a sectional view schematically illustrating an alternative embodiment of a hot pressing step.

FIG. 15 is a view schematically illustrating an embodiment of the preparing of a prepreg to be used for a production method of the present invention.

FIGS. 16(a) to 16(e) are sectional views illustrating the steps in a producing process of a hybrid substrate in accordance with an embodiment of the present invention (spaced tile arrangement).

FIGS. 17(a) to 17(b) are sectional views illustrating the steps in a producing process of a hybrid substrate in accordance with an embodiment of the present invention (spaced tile arrangement).

FIGS. 18(a) to 18(f) are sectional views illustrating the steps in a producing process of a hybrid substrate in accordance with an embodiment of the present invention (tile arrangement with frame member).

FIGS. 19(a) to 19(b) are sectional views illustrating the steps in a producing process of a hybrid substrate in accordance with an embodiment of the present invention (tile arrangement with frame member).

FIG. 20 is a view schematically illustrating an embodiment wherein a hybrid substrate (or build-up substrate) is subjected to a cutting process.

FIG. 21(a) illustrates a substrate (singulated hybrid substrate 200) obtained by providing build-up layers on a hybrid substrate, followed by cutting it into pieces with the size of a ceramic substrate along a frame member.

FIG. 21(b) illustrates a semiconductor integrated circuit package 300 obtained by further singulating the substrate of FIG. 21(a) for forming a build-up substrate, followed by mounting a semiconductor integrated circuit thereon.

### DETAILED DESCRIPTION OF THE INVENTION

Hereinafter, some embodiments of the present invention are described with reference to Figures. In the following Figures, the same reference numeral indicates the element which has substantially the same function for simplified explanation. The dimensional relationship (length, width, thickness and so forth) in each Figure does not reflect a practical relationship thereof. Furthermore, the term upward referred to or suggested in the present description corresponds to the upward direction in Figures for convenience.

### [Hybrid Substrate of Present Invention]

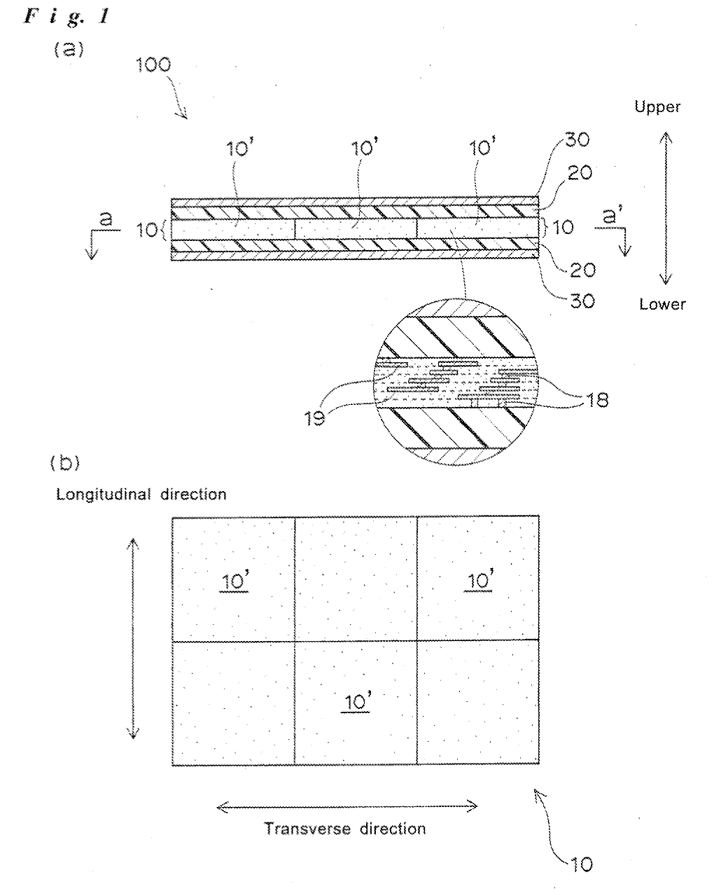

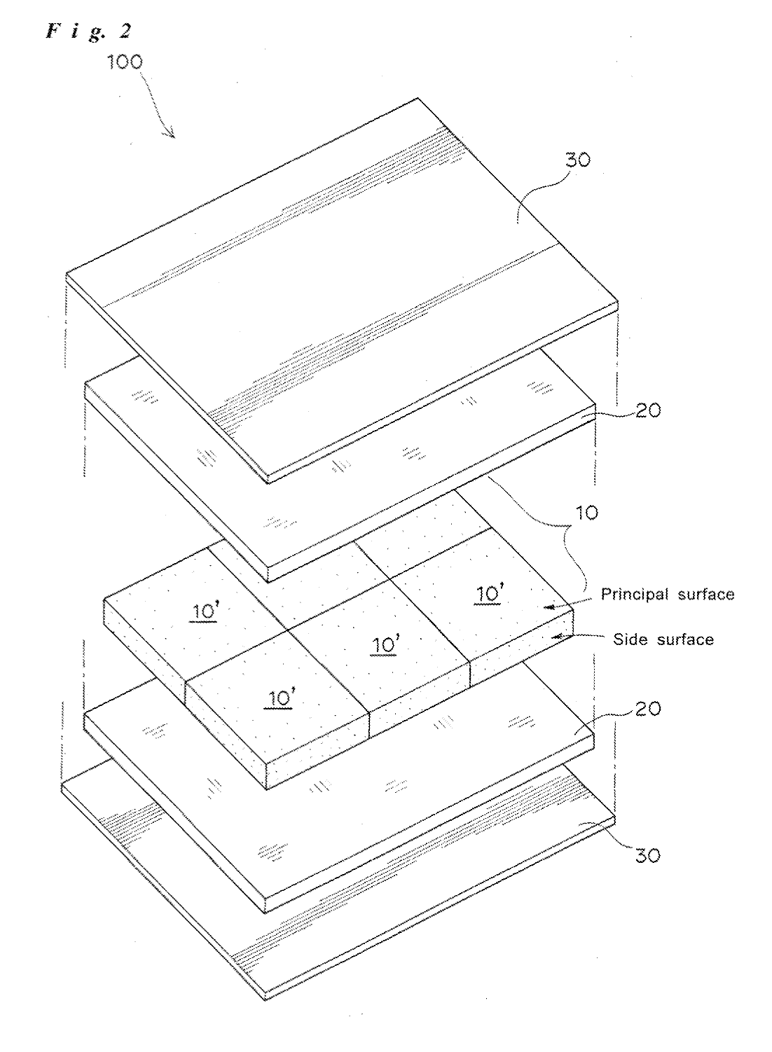

As shown in FIG. 1 and FIG. 2, a hybrid substrate of the present invention 100 is mainly composed of a ceramic substrate assembly 10, an insulating resin layer 20 and a metal layer 30. As shown in these drawings, the insulating resin layers 20 are provided on both surfaces of ceramic substrate assembly 10, and the metal layer 30 is provided on each of the insulating resin layers 20. In other words, the ceramic substrate assembly 10 is provided to be interposed between two opposed insulating resin layers 20, and the metal layers 30 are provided on the respective principal surfaces of the insulating resin layers 20.

The ceramic substrate assembly 10 is composed of a plurality of ceramic substrates 10, as shown in FIG. 1(b). In particular according to the present invention, the plurality of ceramic substrates 10 are in the form of a tile arrangement. Specifically, the plurality of ceramic substrates 10 in the present invention are arranged closer together in the same plane. The term same plane as used herein substantially means a plane positioned between the two insulating resin layers 20, the plane being generally parallel to each principal surface of the insulating resin layers 20. That is, according to the present invention, a plurality of ceramic substrates are arranged along the same plane positioned between the two opposed insulating resin layers such that the substrates do not mutually overlap. In one preferred embodiment of the present invention, all the upper principal surfaces of the plurality of ceramic substrates are positioned in the same plane, and/or, all the lower principal surfaces of the plurality of ceramic substrates are positioned in the same plane.

Each of the ceramic substrates 10 which constitute the assembly 10 may be a ceramic multilayer substrate obtained by stacking a plurality of green sheets, followed by firing thereof. There is no particular limitation on the material and the entire dimensions of the ceramic multilayer substrates as long as they have conventionally been used or employed in the field of an electronic equipment (for example, in the field of a package wiring substrate of a semiconductor integrated circuit LSI). In this respect, each ceramic substrate per se does not have to be large-sized, and thus it may have a small size. That is, the dimensions of L:transverse width×W:longitudinal width×T:thickness with respect to the ceramic substrate 10 may be comparatively small, such as L: about 75 to 175 mm×W: about 75 to 175 mm×T: about 250 to 700 μm (for example, L: about 110 mm×W: about 110 mm×T: about 400 μm).

For example, as shown in FIG. 1(a), at least one of the plurality of ceramic substrates 10 is provided with inner via 18, wiring layer 19 and/or the like. In particular as for the ceramic multilayer substrate, the respective wiring layers 19 are electrically connected with each other through the inner vias 18.

There is no particular limitation on the number of ceramic substrates 10 as long as the hybrid substrate with a desired size can be provided. For example, the number of ceramic substrates in one hybrid substrate may be in the range of approximately 2 to 40, preferably in the range of approximately 4 to 20 (for example, 6 sheets of substrates). If there is no specific requirement, it is preferred that the sizes or shapes of respective ones of the substrates 10 are the same as each other on the whole. For example in a case where six ceramic substrates 10 are used, it is preferred that, as shown in FIG. 1(b), a ceramic substrate assembly 10 entirely has a rectangular shape wherein the two ceramic substrates 10 each having the same shape and the same size are arranged in a longitudinal array direction and the three ceramic substrates each having the same shape and the same size are arranged in a transverse array direction. The number of the ceramic substrates 10 can be directly involved in the size of a hybrid substrate size. For example in the case of the six ceramic substrates 10, the hybrid substrate 100 has the size (especially size of the principal surface) that is at least 6 times larger than that of each ceramic substrate 10. That is, the hybrid substrate according to the present invention can, at the very least, have the principal surface size whose value is obtained from the number of the ceramic substrates to be used, multiplied by the size of the principal surface of one ceramic substrate 10.

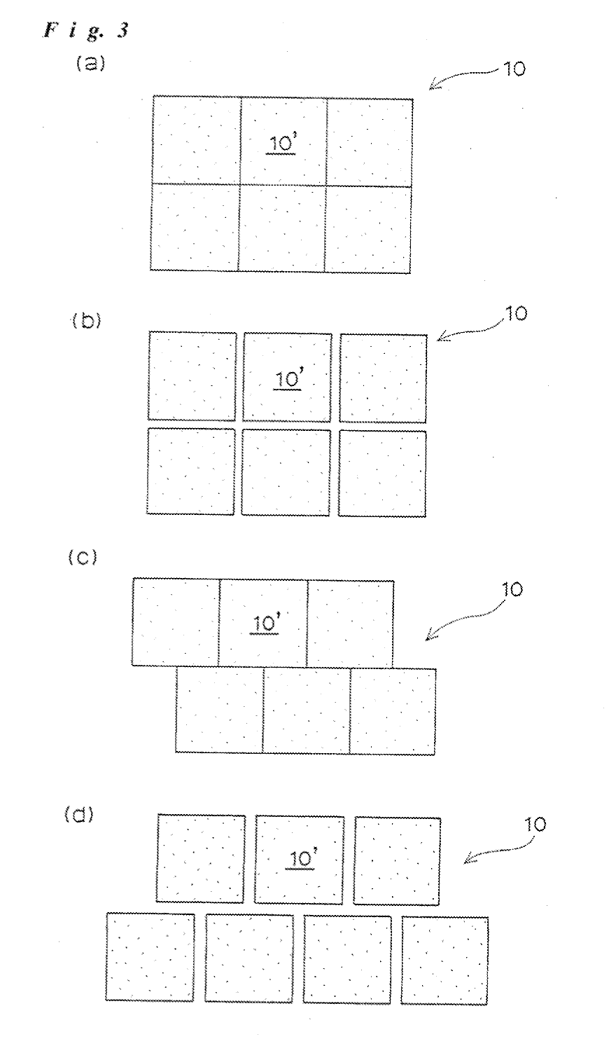

With respect to the tile arrangement, the plurality of ceramic substrates 10 are in close contact with each other as shown in FIG. 3(a), or the plurality of ceramic substrates are spaced from each other as shown in FIG. 3(b). Furthermore, as shown in FIG. 3(c) and FIG. 3(d), the plurality of ceramic substrates 10 may be in the form of staggered tile arrangement constructed by a mutual shift of their arrays.

The insulating resin layer 20 of the hybrid substrate is constituted from at least a reinforcing material and a resin material. Preferably, the insulating resin layer 20 is an insulating adhesive layer. The insulating resin layer may additionally contain filler materials capable of adjusting thermal conduction, elastic modulus and/or thermal expansion. In the hybrid substrate of the present invention, the ceramic substrate assembly 10 and the metal layer 30 are suitably bonded to each other by the insulating adhesive layer 20. For example, the insulating adhesive layer may be made one from a prepreg.

The reinforcing material of the insulating resin layer 20 may be an inorganic or organic woven cloth (i.e. woven fabrics) or nonwoven cloth/nonwoven fabrics (i.e. paper). Just as an example, a glass cloth (glass fiber knitted cloth) is used as inorganic woven cloth, an aramid woven fabric is used as organic woven cloth, a glass nonwoven paper is used as inorganic nonwoven paper and an aramid nonwoven paper is used as organic nonwoven paper, respectively. While on other hand, the resin material of the insulating resin layer 20 is preferably a thermosetting resin. For example, an epoxy resin, phenol resin or the like may be used as the thermosetting resin.

The insulating resin layer 20 can be formed from the prepreg, i.e. precursor obtained by impregnating a glass cloth, which is produced by reticulately knitting glass fibers, with a thermosetting resin solution. The heat treatment of the prepreg (i.e. precursor) leads to a formation of the insulating resin layer 20. In the case of the insulating resin layer 20 made from the prepreg, a thermosetting resin component can be provided in the vicinity of principal surfaces of the glass cloth (i.e., front and back surfaces of the glass cloth) of the layer.

It is preferred that the insulating resin layer 20 is also provided with an electrically-conductive portion such as a via and the like. In this case, the electrically-conductive portion of the insulating resin layer may be electrically connected to another electrically-conductive portion of the ceramic substrate assembly 10 and/or the metal layer 30.

According to the hybrid substrate of the present invention, the ceramic substrate assembly 10 is interposed between the insulating resin layers 20. Accordingly, the size of the insulating resin layer 20 is comparatively large. That is, the insulating resin layer 20 can have the large size of the principal surface capable of covering the plurality of ceramic substrates 10. For example, the dimensions of L:transverse width×W:longitudinal width×T:thickness with respect to the insulating resin layer 20 may be comparatively large, such as L: about 255 to 600 mm×W: about 255 to 600 mm×T: about 30 to 120 μm (for example, L: about 510 mm×W: about 510 mm×T: about 50 μm).

The metal layer 30 of the hybrid substrate may be made from a metal component such as copper or aluminum. Preferably, the metal layer 30 is constituted from a metal foil such as a copper foil or an aluminum foil. The thickness of the metal layer 30 is in the range of approximately 2 to 500 μm, preferably in the range of approximately 12 to 125 μm (for example, about 35 μm).

Similarly to the insulating resin layer 20, the size of the metal layer 30 is also comparatively large. That is, the metal layer 30 can have a large size of the principal surface capable of covering the plurality of ceramic substrates 10. For example, the dimensions of L:transverse width×W:longitudinal width with respect to the principal surface of the metal layer 30 may be comparatively large, such as L: about 300 to 700 mm×W: about 300 to 700 mm (for example, L: about 530 mm×W: about 530 mm).

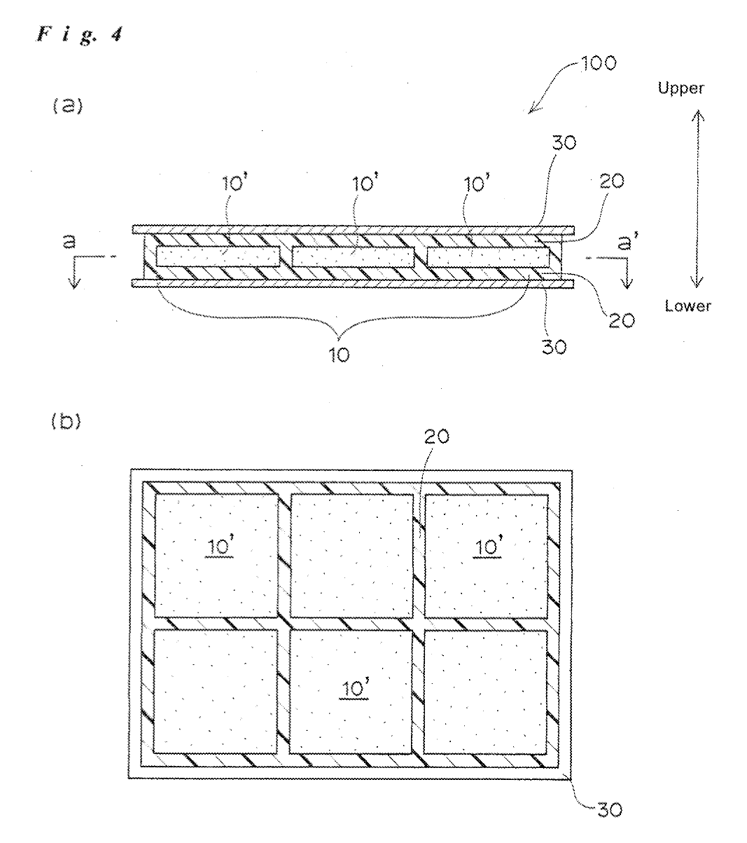

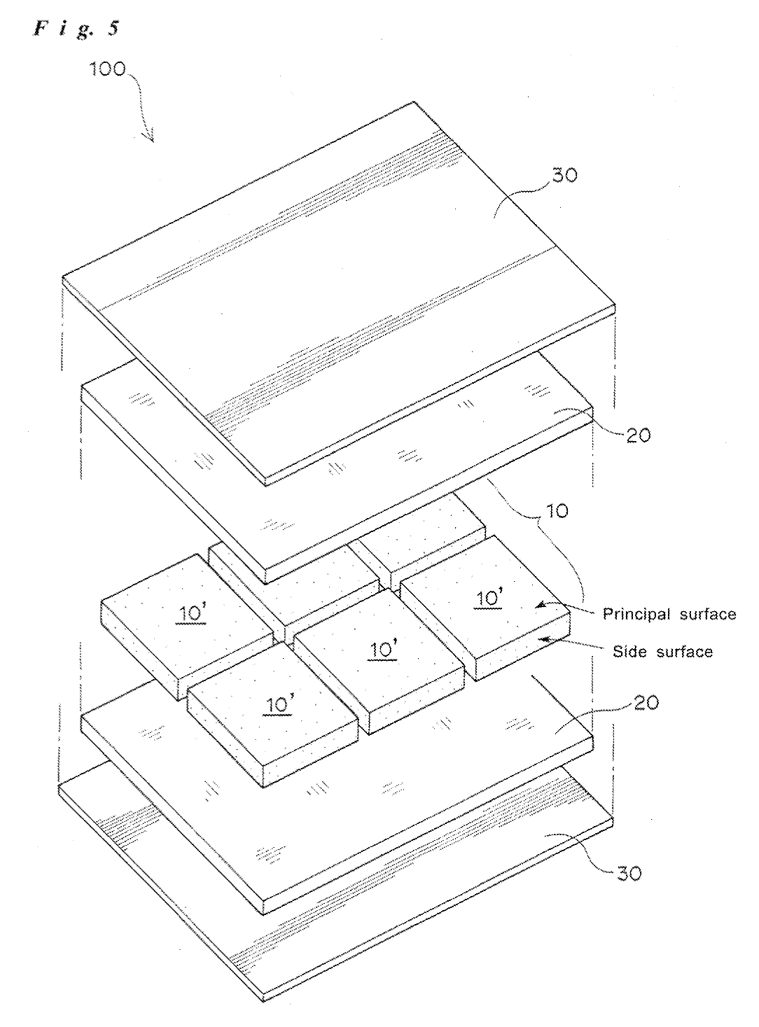

Now, the characterizing feature tiling of the present invention will be described in detail below. In the present invention, the plurality of ceramic substrates (preferably, the plurality of ceramic substrates having the same size and the same shape as each other) are arranged in a tile form, and thus they are positioned on the same plane between the insulating resin layers. In one preferred embodiment, all the upper principal surfaces of the plurality of ceramic substrates are on the same level, and/or, all the lower principal surfaces of the plurality of ceramic substrates are on the same level. The tile arrangement may be not only close-contacted tile arrangement as shown in FIG. 1 and FIG. 2, but also spaced tile arrangement as shown in FIG. 4 and FIG. 5. That is, the plurality of ceramic substrates 10 may be provided in a state of being mutually contacted in the same plane between the insulating resin layers (FIG. 1 and FIG. 2), and may also be alternatively provided in a state of being at mutual spaced intervals in the same plane between the insulating resin layers (FIG. 4 and FIG. 5).

In the case of spaced tile arrangement shown in FIG. 4 and FIG. 5, the ceramic substrates are spaced apart preferably by approximately 0.5 to 10.0 mm, more preferably by approximately 2.0 to 5.0 mm. In this spaced arrangement, when the hybrid substrate or a build-up substrate using the same is subjected to a cutting process to obtain a desired size, it is possible to easily cut it along the spaced portions of the substrates. This means that the size of the hybrid substrate or build-up substrate can be easily adjusted on a basis of the size of ceramic substrate.

The hybrid substrate of the present invention can be suitably handled as an integrated large-sized substrate even though the plurality of ceramic substrates are used in a spaced form. This is because the plurality of ceramic substrates are suitably held by the insulating resin layers 20 such that the substrates are sandwiched between the insulating resin layers 20 constituted from the reinforcing material (e.g., woven cloth or nonwoven paper) and the resin.

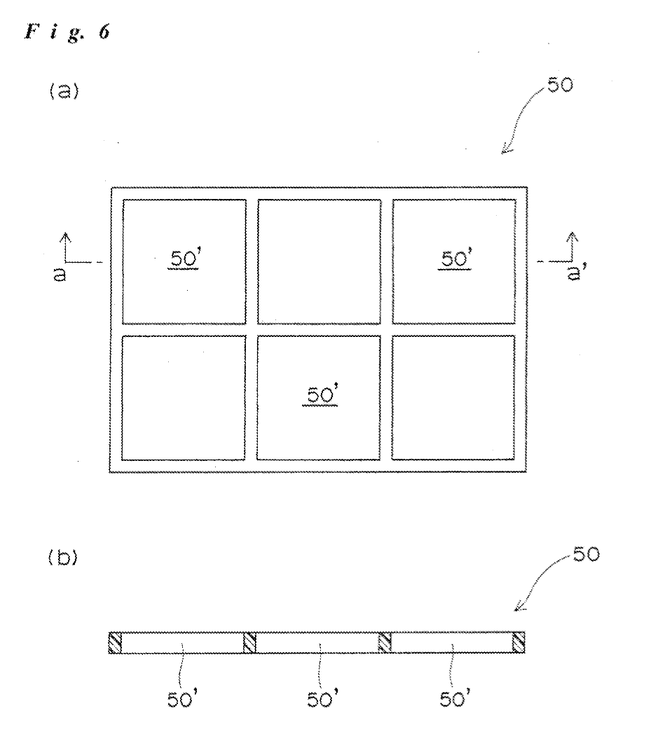

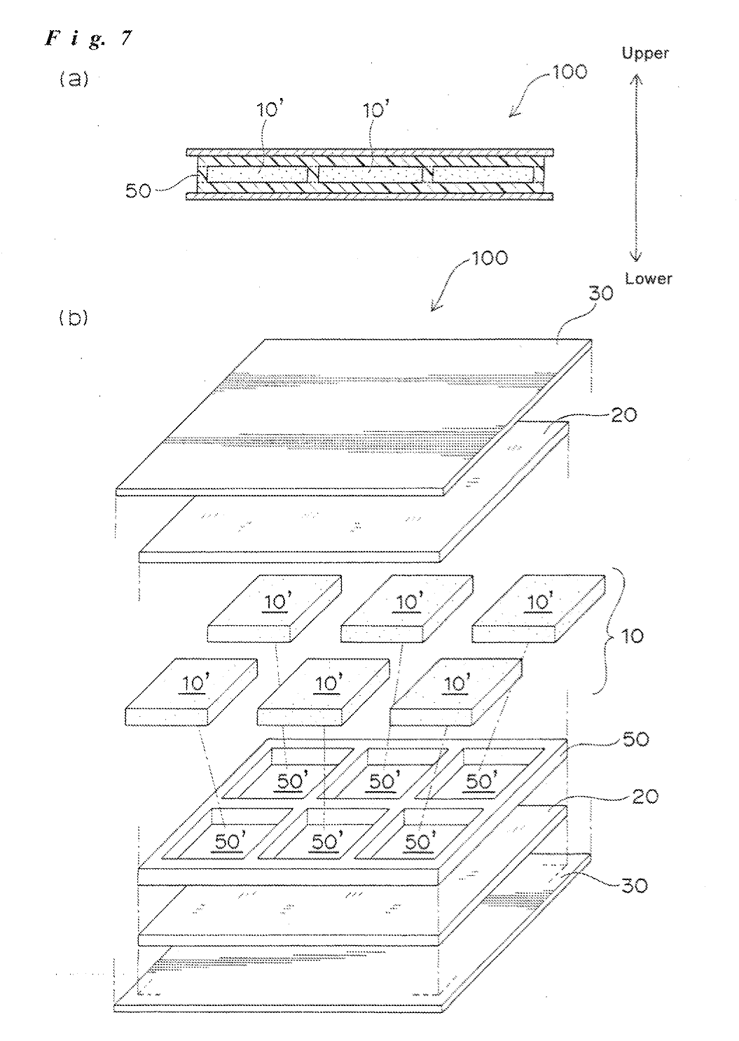

In the case of spaced tile arrangement, a frame member 50 as shown in FIG. 6 may be used. That is, a frame member 50 having a plurality of hollow portions 50 in its body may be used. With respect to the spaced tile arrangement of the ceramic substrates, as shown in FIGS. 7(a) and 7(b), the respective ones of ceramic substrates 10 are positioned such that they are fitted into the individual hollow portions 50. The plurality of ceramic substrates 10 and the frame member 50 are integrated with each other so that the plurality of ceramic substrates are more precisely spaced apart from each other between the opposed insulating resin layers. In order that the ceramic substrates 10 are positioned within the hollow portions 50 of the frame member 50 and are suitably integrated with the frame member, it is preferred that each ceramic substrate 10 and each hollow portion 50 are substantially the same as each other in size and shape. There is no particular limitation on the material of the frame member, and thus for example, the frame member may be made of a resin. Just as an example, the resin material of the frame member may be the same as that of the insulating resin layer 20.

In the case where the frame member 50 is used in the hybrid substrate, there can be improved an accuracy of the mutual positioning of the ceramic substrates 10. Further, in the case of the frame member 50, the framing portion thereof can be used as a alignment mark. In this regard, for example when a hole is formed in the framing portion (i.e., the portion from which the hollow portions of the frame member 50 are formed), some process (e.g., etching process) for the metal layer 30 can be carried out on the basis of the hole wherein such processing of the metal layer can be precisely performed at a desired position. Furthermore, when the hybrid substrate or the build-up substrate using the same is cut to give a desired size of the substrate, it is possible to easily perform the cutting process along the framing portions of the frame member.

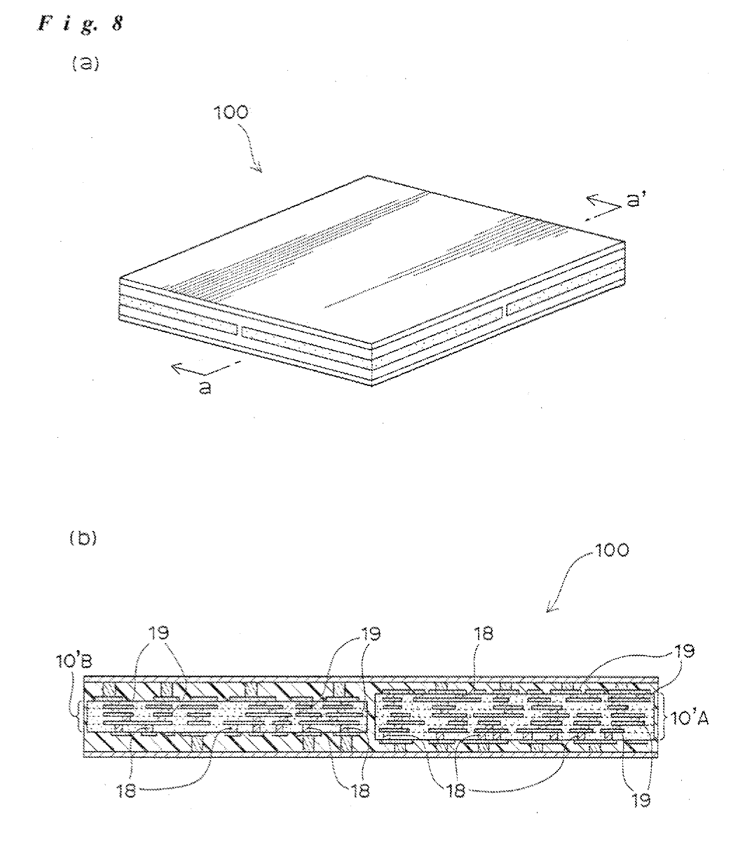

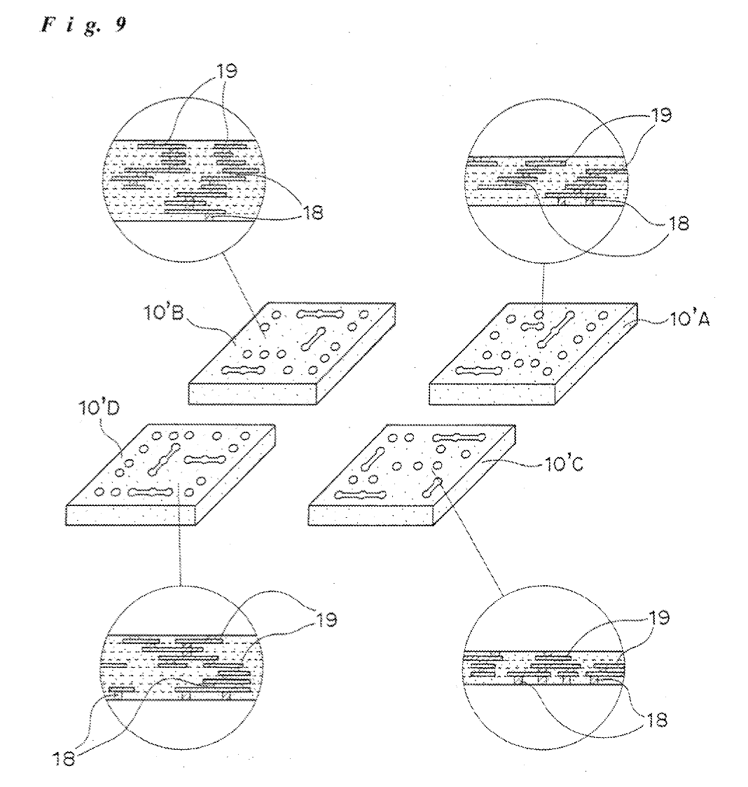

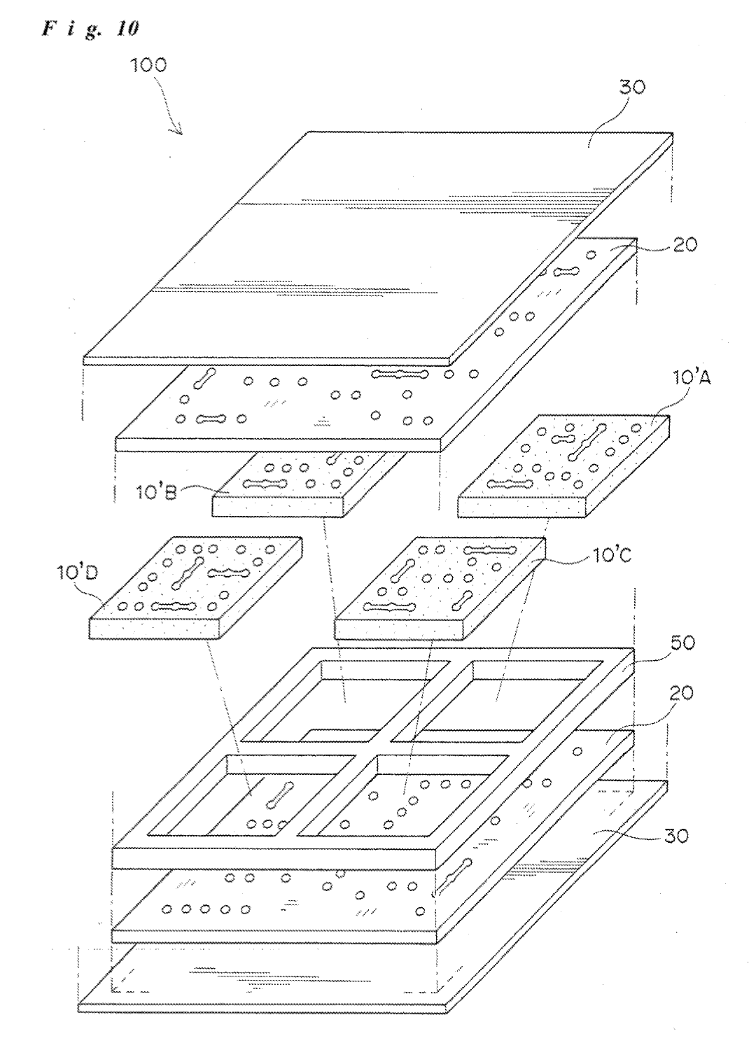

In the hybrid substrate of the present invention, at least one of the plurality of ceramic substrates may have an inner via therein as shown in FIG. 8 to FIG. 10. Whereby, a multilayer structure can be suitably constructed, and as a result a build-up substrate or electronic circuit with a desired multilayer structure can be finally obtained. This leads to a realization of a highly densified build-up substrate or electronic circuit module. As shown in FIG. 8 to FIG. 10, the plurality of ceramic substrates (especially at least two ceramic substrates) may respectively have the inner vias 18 whose configurations are different from each other. For example, FIG. 8(b) shows that the structures of the inner vias 18 are mutually different in a ceramic substrate 10 A and a ceramic substrate 10 B. Similarly, FIG. 9 also shows that the configurations of the inner vias 18 are mutually different among the ceramic substrates 10 A to 10 D. In this case of the different configurations of the inner vias, there can be improved a design degree of freedom for various patterns including via, wiring layer, circuit, electrode and terminal of the substrate as a whole. For example, there can be obtained a substrate with a locally valuable portion therein. Furthermore, the different configurations of the inner vias will lead to an achievement of the production of various kinds of substrates with satisfactory productivity. For example in a case where the build-up substrate using the ceramic substrate is singulated, there can be obtained singulated substrates with different structures from each other through the simplified same process.

Similarly, in the hybrid substrate of the present invention, at least one of the plurality of ceramic substrates may have at least one wiring layer on a surface or inside thereof as shown in FIG. 8 to FIG. 10. Whereby, a multilayer structure can be suitably constructed, and as a result a build-up substrate or electronic circuit with a desired multilayer structure can be finally obtained. As shown in FIG. 8 to FIG. 10, the plurality of ceramic substrates (especially at least two ceramic substrates) may respectively have the wiring layers 19 whose numbers or forms are different from each other. For example, FIG. 8(b) shows that the number of layers and wiring shape with respect to the wiring layer 19 are mutually different in a ceramic substrate 10 A and a ceramic substrate 10 B. Similarly, FIG. 9 also shows that the numbers of the wiring layers as well as the wiring shapes are mutually different among the ceramic substrates 10 A to 10 D (see reference numeral 19). In this case of the different number of layers and/or the different wiring shape with respect to the wiring layer, there can be improved a design degree of freedom for various patterns including via, wiring layer, circuit, electrode and terminal of the substrate as a whole. For example, there can be obtained a substrate with a locally valuable portion therein. Furthermore, the different number of layers and/or the different wiring shape regarding the wiring layer will lead to an achievement of the production of various kinds of substrates with satisfactory productivity. For example in a case where the build-up substrate using the ceramic substrate is singulated, there can be obtained singulated substrates with different structures from each other through the simplified same process. In these regards, it should be noted that, even if the numbers of layers regarding the wiring layer 19 are mutually different among the ceramic substrates, a stable productivity can be provided since the thicknesses of the ceramic substrates (after-firing thicknesses) can be closely matched with each other by adjusting the thicknesses of the green sheets (i.e. before-firing thicknesses), and thereby a uniform pressure can be applied on the ceramic substrates during the hot pressing process (i.e. process after the tile arrangement).

### (Method for Producing Hybrid Substrate of the Present Invention)

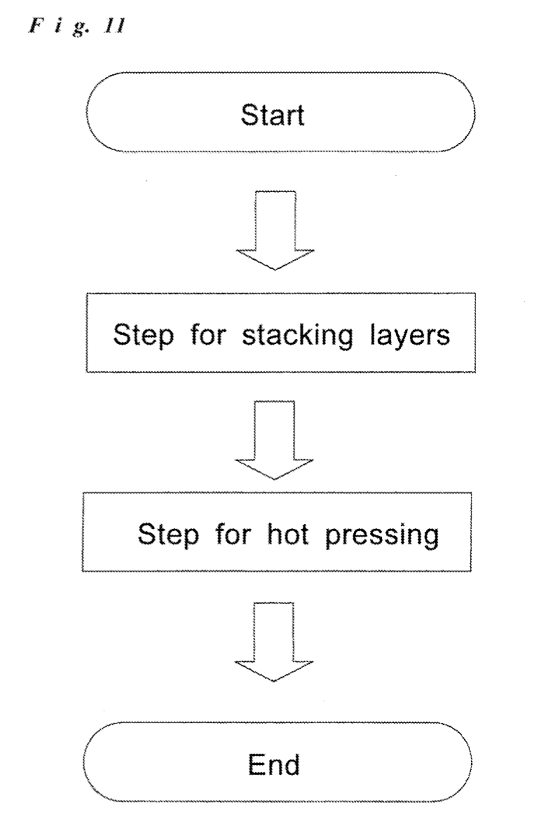

With reference to FIG. 11 to FIG. 15, the method for producing a hybrid substrate of the present invention will be described below. The production method of a hybrid substrate according to the present invention typically comprises step of stacking layers and step of hot pressing, as shown in FIG. 11 (process flow).

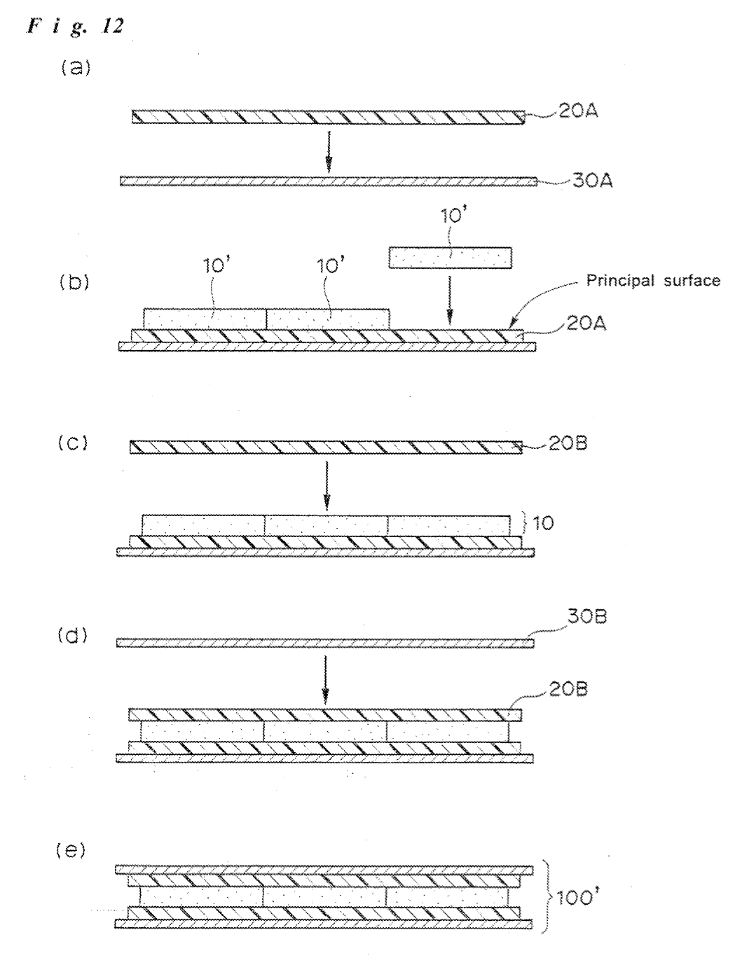

Upon carrying out the production method of the present invention, the step (i) as the stacking-layers step is firstly performed. That is, a first insulating resin layer precursor 20A is disposed on a first metal foil 30A as shown in FIG. 12(a). As the first metal foil 30A, a copper foil can be used. It is preferred that the first metal foil has a large size suited for tile arrangement of ceramic substrates to be performed hereinafter. For example, the dimensions of L:transverse width×W:longitudinal width×T:thickness with respect to the first metal foil may be comparatively large, such as L: about 370 to 630 mm×W: about 370 to 630 mm×T: about 12 to 150 μm (for example, L: about 370 mm×W: about 530 mm×T: about 35 μm).

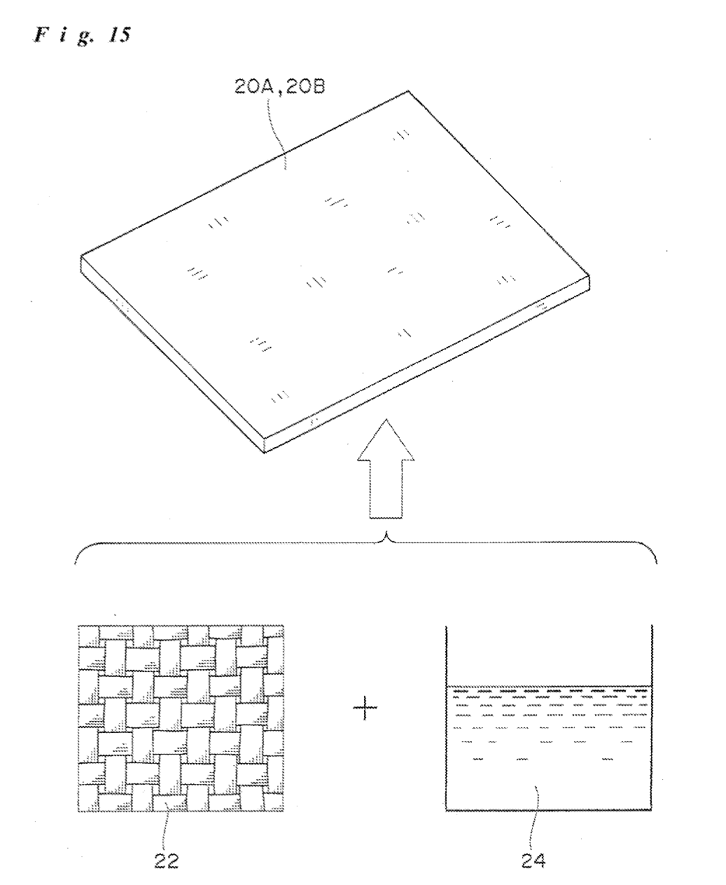

The first insulating resin layer precursor 20A may be an insulating adhesive layer. In this regard, the precursor 20A may be a prepreg which is made at least of a reinforcing material and a resin precursor. For example, the prepreg may be one obtained by impregnating a glass cloth 22, that is produced by reticulately knitting glass fibers having a diameter of about 6 μm to 9 μm, with a thermosetting resin solution 24 (e.g., a resin solution which comprises a resin component and an organic solvent component). See FIG. 15.

It is preferred that the prepreg also has a large size suited for tile arrangement of ceramic substrates to be performed hereinafter, similarly to the first metal foil 30A. For example, the dimensions of L:transverse width×W:longitudinal width×T:thickness with respect to the prepreg may be comparatively large, such as L: about 255 to 600 mm×W: about 255 to 600 mm×T: about 30 to 120 μm (for example, L: about 340 mm, W: about 510 mm and T: about 40 μm). It should be noted that the prepreg is particularly suited for the production of large size, which leads to an achievement of producing the hybrid substrate at low costs. The reason for this is that the productivity of the prepreg is much higher as compared with that of a doctor blade process, due to the fact that the prepreg can be obtained by impregnating the reinforcing material with the thermosetting resin solution.

In a case where a via connection between a ceramic core substrate and a metal layer is performed by the use of a prepreg (i.e., insulating resin layer), holes are formed in the prepreg, followed by the holes thus formed being filled with an electrically conductive paste. Specific embodiment regarding this is as follows:

The prepreg is subjected to a through-hole processing (about 70 to 130 μm) by means of a pulsed laser using a carbon dioxide laser. Since the pulsed laser can be scanned by a galvanometer mirror and fθ lens, the holes can be formed at desired positions under a high-speed process condition (for example, 100 holes/second). The through-holes thus formed are filled with an electrically conductive paste. The electrically conductive paste is preferably a resin-based electrically conductive paste. In this resin-based electrically conductive paste, a composite powder obtained by coating a copper powder whose mean particle diameter of 2 to 6 μm with about 1 to 4% of silver may be used. A desired resin-based electrically conductive paste can be obtained by adding 4 to 19% by weight of a liquid epoxy resin (bisphenol F type epoxy) and a latent curing agent powder in the amount of about 10% by weight(e.g., approximately 0.5 to 2.0% by weight) of the liquid epoxy resin to 80 to 95% by weight of the composite powder, kneading the resultant mixture using a planetary mixer, and then kneading again using a three-roll machine.

Subsequent to the step (i), the step (ii) as the stacking-layers step is performed. That is, a ceramic substrate assembly 10 composed of a plurality of ceramic substrates 10 is disposed on the first insulating resin layer precursor 20A (see FIG. 12(b)).

Each of the ceramic substrates 10 used in the step (ii) may be a ceramic multilayer substrate. Such ceramic multilayer substrate can be obtained by subjecting the stacking of the green sheets to a firing process. More specific embodiments regarding this is as follows:

First, the holes (size: approximately 50 μm to 200 μm) are formed in the green sheet by means of a numerical control punch press (NC punch press), a carbon dioxide laser or the like. The holes thus formed are filled with an electrically conductive paste material which serves as a raw material for inner vias. A firing type circuit pattern including a wiring layer or the like is also formed on the green sheet. Subsequently, the predetermined numbers of the green sheets are stacked onto each other, followed by subjecting them to a thermocompression process to bond the stacked green sheets together. The stacked green sheets thus formed are then subjected to a firing process, and thereby a ceramic multilayer substrate is finally produced.

The green sheet per se may be in a form of sheet which comprises a ceramic component, a glass component and an organic binder component. For example, the ceramic component may be an alumina powder (mean particle diameter: approximately 0.5 to 10 μm) and the glass component may be a borosilicate glass powder (mean particle diameter: approximately 1 to 20 μm). The organic binder component may be, for example, at least one kind of components selected from the group consisting of a polyvinyl butyral resin, an acrylic resin, a vinyl acetate copolymer, polyvinyl alcohol and a vinyl chloride resin. Just as an example, the green sheet may be composed of an alumina powder in the amount of 40 to 50% by weight, a glass powder in the amount of 30 to 40% by weight and an organic binder component in the amount of 10 to 30% by weight (based on the total weight of the green sheet). From another point of view with respect to the green sheet, a weight ratio of a solid component (e.g., an alumina powder in the amount of 50 to 60% by weight and a glass powder in the amount of 40 to 50% by weight, based on the weight of the solid component) to an organic binder component, namely, a ratio of the solid component to the organic binder component by weight may be in the range of 80:20 to 90:10. As the green sheet component, other components may be optionally used. For example, plasticizers capable of imparting flexibility to the green sheet, such as ester phthalate and dibutyl phthalate; dispersants of ketons such as glycol; organic solvents; and the like may be contained in the green sheet. The thickness per se of each green sheet may be in the range of approximately 30 μm to 500 μm (for example, approximately 60 μm to 350 μm).

According to the present invention, there is no need for the principal surface of the green sheet to have particularly large size. In other words, the principal surface of the green sheet may have a small size. For example, the dimensions of L:transverse width×W:longitudinal width with respect to the size of the principal surface of the green sheet may be comparatively small, such as L: about 75 to 175 mm×W: about 75 to 175 mm (for example, L: about 110 mm×W: about 110 mm).

The electrically conductive paste material as a raw material of the inner vias can be filled into the holes of the green sheet by any suitable one of the various printing methods. The electrically conductive paste material as a raw material of the wiring layer can also be supplied on a surface of the green sheet by any suitable one of the various printing methods. Such electrically conductive pastes to be used as raw materials of the inner vias and the wiring layers may be one which contains a Ag powder, a glass frit for a bonding strength, and an organic vehicle (e.g., an organic mixture of ethyl cellulose and terpineol), for example. By subjecting the electrically conductive paste of the green sheet to a heat treatment, the inner vias and the wiring layer can be formed therefrom. The heat treatment per se of the above electrically conductive paste material is spontaneously performed during the firing of the stacked green sheets (it should be noted that, prior to the firing of the stacked green sheet, the electrically conductive paste may be subjected to a drying treatment).

There is no particular limitation on the number of green sheet with respect to the stacked green sheets. The total number of the green sheets in one stacking thereof may be in the range of approximately 3 to 50, and more preferably from approximately 3 to 15.

It is preferred that, prior to the firing process, the stacked green sheets are subjected to a decomposition/desorption treatment of the organic substance, such as a debinding step (i.e. burnout treatment of the binder). For example, the stacked green sheets may be subjected to a heat treatment of the debinding step under a temperature condition of 500° C. to 700° C. for approximately 20 to 50 hours. As for the firing step being carried out after the debinding step, the stacked green sheets are preferably subjected to a heat treatment under a temperature condition of 800° C. to 1000° C. (preferably 850° C. to 950° C.) for about 0.1 hour to 3 hours, for example. Such heat treatment may be performed by placing the stacked green sheet in a firing furnace (e.g. mesh belt furnace). Such firing process is disclosed in JP-A-5-102666, and thus refer to it if necessary.

In the step (ii) of the present invention, a plurality of ceramic substrates 10 are disposed in the form of a tile arrangement so that they are closer along the same plane, as shown in FIG. 12(b). That is, the plurality of ceramic substrates 10 are arranged along the same plane so as not to be mutually overlapped and they are all generally parallel to a principal surface of the first insulating resin layer precursor 20A. With respect to the tile arrangement, the plurality of ceramic substrates 10 may be mutually in close contact as shown in FIG. 3(a), or a plurality of ceramic substrates 10 may be mutually spaced apart as shown in FIG. 3(b). Furthermore, as shown in FIG. 3(c) and FIG. 3(d), a plurality of ceramic substrates 10 may be disposed in a form of the staggered array of the column or row thereof.

As a means for disposing the ceramic substrates, various mechanical means are available. For example, a handling means with a suction and adsorption mechanism can be used, and thereby the plurality of ceramic substrates 10 are provided on the first insulating resin layer precursor 20A.

Subsequent to the step (ii), the step (iii) as the stacking-layers step is performed. Specifically, as shown in FIGS. 12(c) to 12(e), a second insulating resin layer precursor 20B is disposed on the ceramic substrate assembly 10, and then a second metal foil 30B is disposed on the second insulating resin layer precursor 20B to form a hybrid substrate precursor 100.

In other words, through the steps (i) to (iii), the plurality of ceramic substrates 10 having a form of the tile arrangement are sandwiched from both sides thereof by the first insulating resin layer precursor 20A (and the first metal layer 30A thereon) and the second insulating resin layer precursor 20B (and the second metal layer 30B thereon).

The second insulating resin layer precursor 20B used in step (iii) may be the same as the first insulating resin layer precursor 20A used in the step (i). That is, the second insulating resin layer precursor 20B may be a prepreg made at least of a reinforcing material and a resin precursor. For example, the prepreg may be one obtained by impregnating a glass cloth 22, that is produced by reticulately knitting glass fibers having a diameter of approximately 6 μm to 9 μm, with a thermosetting resin solution 24 (see FIG. 15).

Similarly, the second metal foil 30B used in the step (iii) may be the same as the first metal foil 30A used in the step (i). That is, the second metal foil 30B may be a copper foil.

For suitably interposing the plurality of ceramic substrates between the insulating resin layer precursors and metal foils, it is preferred that the size of the principal surface of the second insulating resin layer precursor 20B is substantially the same as that of the first insulating resin layer precursor 20A, and that the size of the principal surface of the second metal foil 30B is also substantially the same as that of the first metal foil 30A.

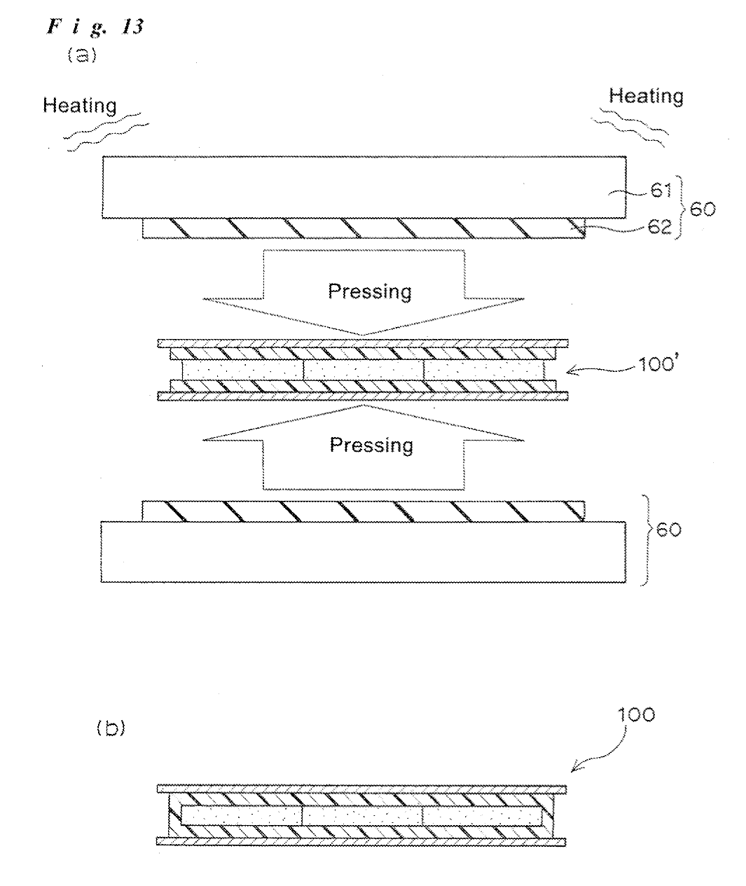

Subsequent to the step (iii), the step (iv) of hot pressing is performed. Specifically, a hybrid substrate precursor 100 is subjected to a press treatment under a heating condition to provide a hybrid substrate 100 therefrom, as shown in FIGS. 13(a) and 13(b).

Just as an example, it is preferred that the hot pressing (press time: approximately 0.5 to 2 hours) of the step (iv) is performed under a pressure condition of approximately 0.2 to 4.5 MPa and a temperature condition of approximately 170° C. to 230° C. Prior to the hot pressing, a temporary bonding treatment between the layers may be performed. For example, the temporary bonding treatment may be performed by using a vacuum laminator. To take a single instance, such vacuum laminator may be used at a vacuum degree of approximately 80 to 120 torr and a temperature of 80 to 120° C. under a pressure of approximately 0.2 to 0.8 Pa.

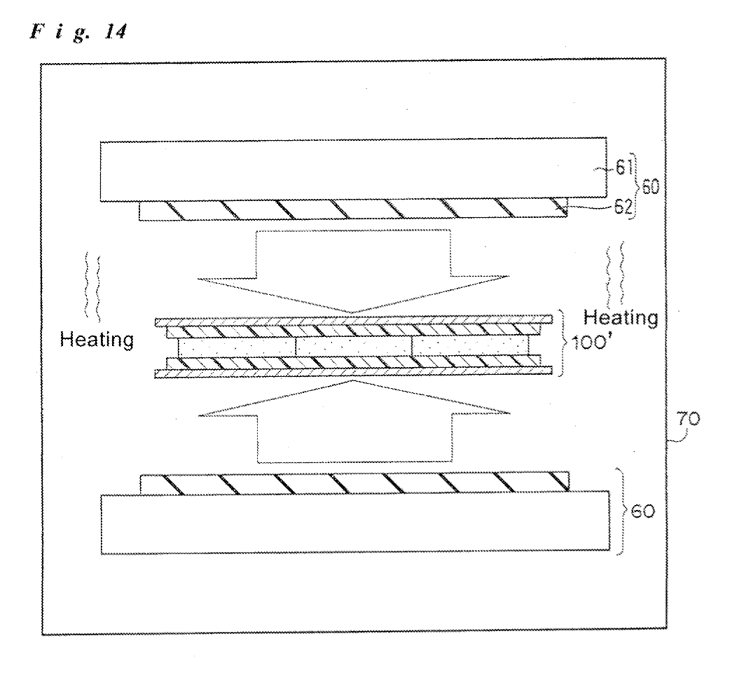

In the step (iv), as shown in FIG. 13(a), the hybrid substrate precursor 100 may be pressed from the outside toward the inside thereof by means of heated pressing parts 60. As shown in FIG. 14, a pressing operation may also be carried out in a state where the hybrid substrate precursor 100 is placed in a heated chamber 70.

As shown in FIG. 8(b), even if there is a difference in thickness between the adjacent ceramic substrates, and thereby a plate thickness difference is caused (the thickness difference per se is attributable to a difference in the stacking number of the ceramic multilayer substrate), the step (iv) of hot pressing in the present invention can serve to sufficiently fill the inside of the substrate with the resin component of the insulating resin layer precursors, leaving no void therein.

Through the above processes, there can be finally obtained a hybrid substrate 100 as shown in FIG. 13(b) or FIG. 2.

### (Spaced Tile Arrangement)

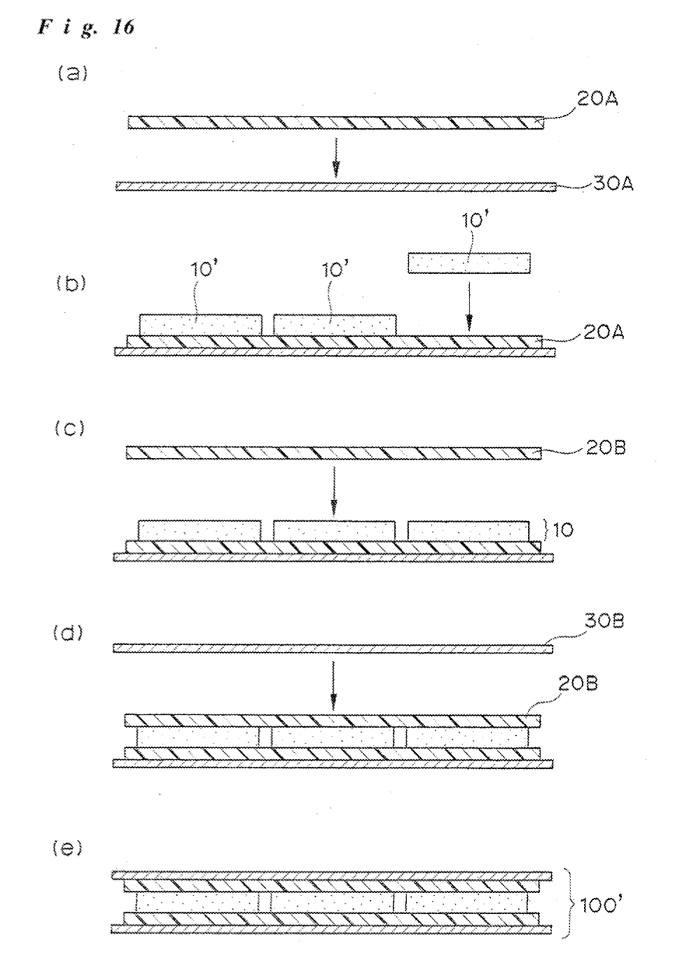

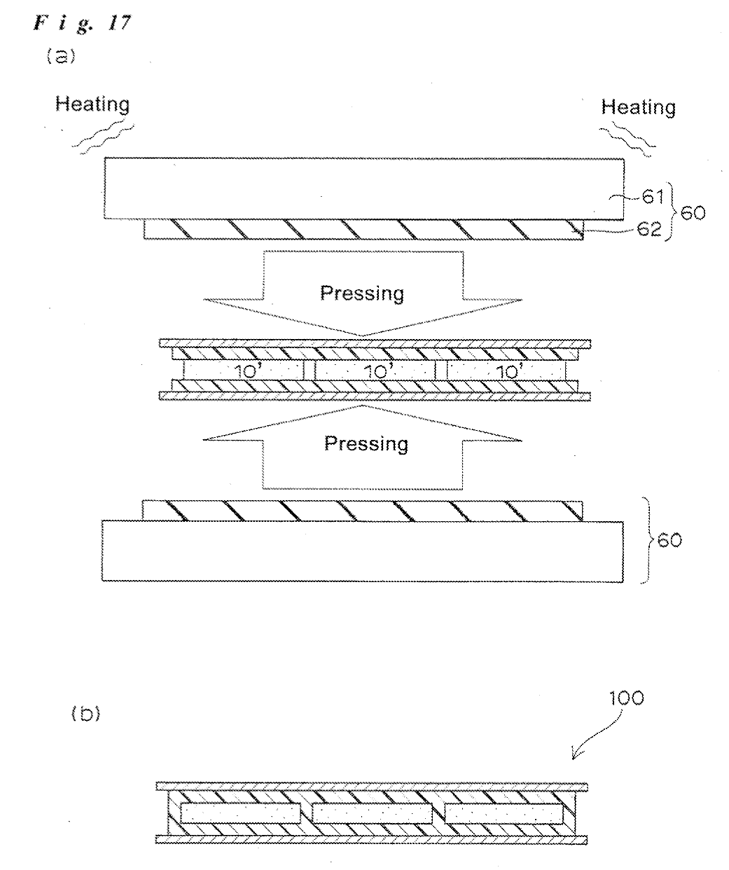

The process of the spaced tile arrangement is shown in FIG. 16 and FIG. 17. Especially, FIG. 16 and FIG. 17 show that the tile arrangement is performed so that the plurality of ceramic substrates are mutually spaced apart in a producing process of the step (ii). Particularly, as is apparent from FIG. 16(b), this tile arrangement is the same as the embodiment of FIGS. 12 to 15, except that the plurality of ceramic substrates 10 are disposed in spaced relation to each other, and thus they are arranged in the same plane and their principal surfaces are generally parallel to the principal surface of the first insulating resin layer precursor 20A. The other processes before and after the spaced tile arrangement are performed in the same manner as those of FIGS. 12 to 15.

In the case of the spaced tile arrangement, clearance gaps are formed between the adjacent ceramic substrates. However, according to the present invention, prepreg made of a reinforcing material and a resin precursor is used, and therefore the clearance gaps are suitably filled with the resin precursor during the hot pressing of the step (iv). This results in no void in the interior of the hybrid substrate. In this regard, the resin component of the precursor serves to fill the clearance gaps, whereas the reinforcing material does not have fluidity and still remains on the tile-arranged ceramic substrates. As a result, the resin can serve as a bonding component between the adjacent ceramic substrates and the reinforcing material can be held on the surfaces of the ceramic substrates, and thereby a remarkably advantageous effect is given wherein not only the strong bonding effect between ceramic substrates is provided, but also the reinforcing effect of the tile arrangement is provided.

(Tile Arrangement with Frame Member)

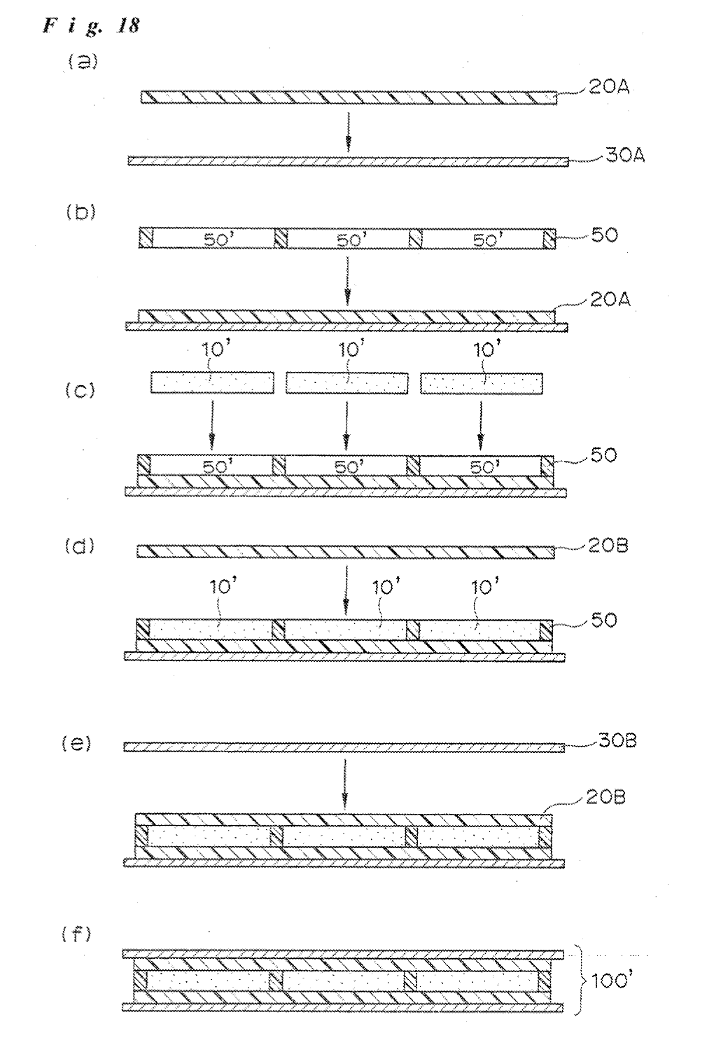

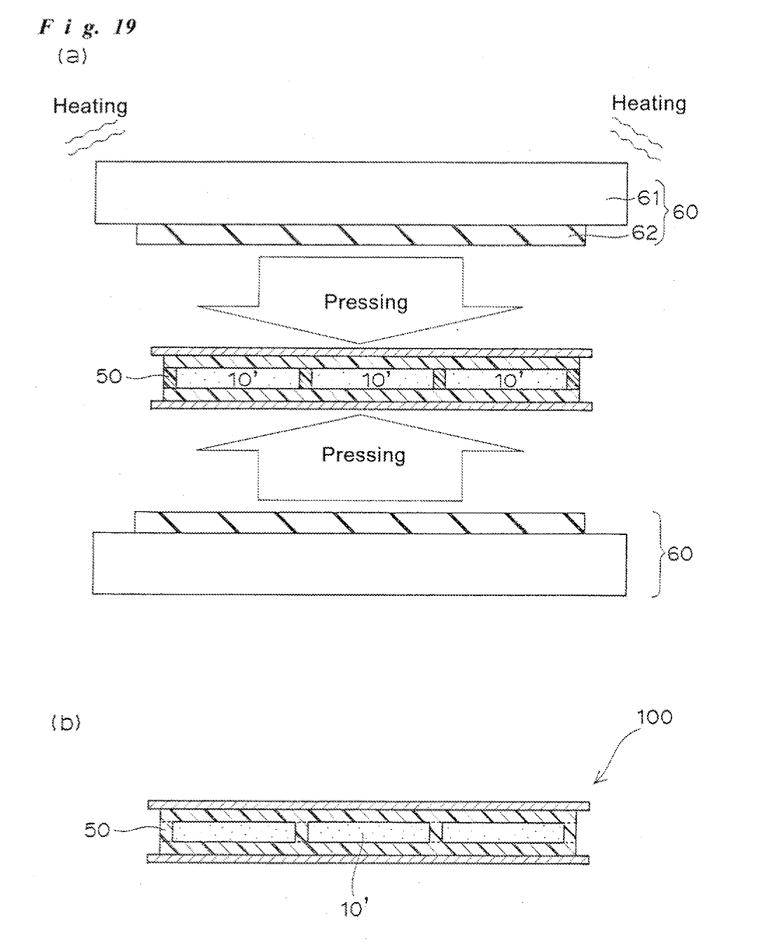

The tile arrangement with the frame member will be described with reference to FIG. 18 and FIG. 19.

As shown in FIG. 18, the tile arrangement is performed wherein the plurality of ceramic substrates 10 are fitted respectively into the hollow portions 50 of a frame member 50, and thereby the ceramic substrates are spaced apart from each other. More specifically, the frame member 50 is disposed on a first insulating resin layer precursor 20A as shown in FIG. 18(b), and subsequently the ceramic substrates 10 are respectively fitted into each of the hollow portions 50 of the frame member as shown in FIG. 18(c). Whereby, the plurality of ceramic substrates form the tile arrangement while being spaced from each other. Except this, the tile arrangement is the same as the embodiment of FIGS. 12 to 15, and thus the other processes before and after the tile arrangement are performed in the same manner as those of FIGS. 12 to 15.

The use of the frame member 50 can increase the accuracy of the positioning for the plurality of ceramic substrates. The order of arrangement of the frame member 50 and the ceramic substrate 10 may be reversed. That is, the frame member 50 may be disposed on the insulating resin layer precursor 20A after disposing the plurality of ceramic substrates 10 on the first insulating resin layer precursor 20A. In this case, a mutual positioning of the ceramic substrate and the frame member is performed by fitting the plurality of ceramic substrates into hollow portions of the frame member on the first insulating resin layer precursor. Furthermore, the frame member 50 integrated with the ceramic substrates 10 may be used. In other words, the plurality of ceramic substrates 10 and the frame member 50 may be preliminarily integrated with each other, followed by being disposed onto the insulating resin layer precursor 20A.

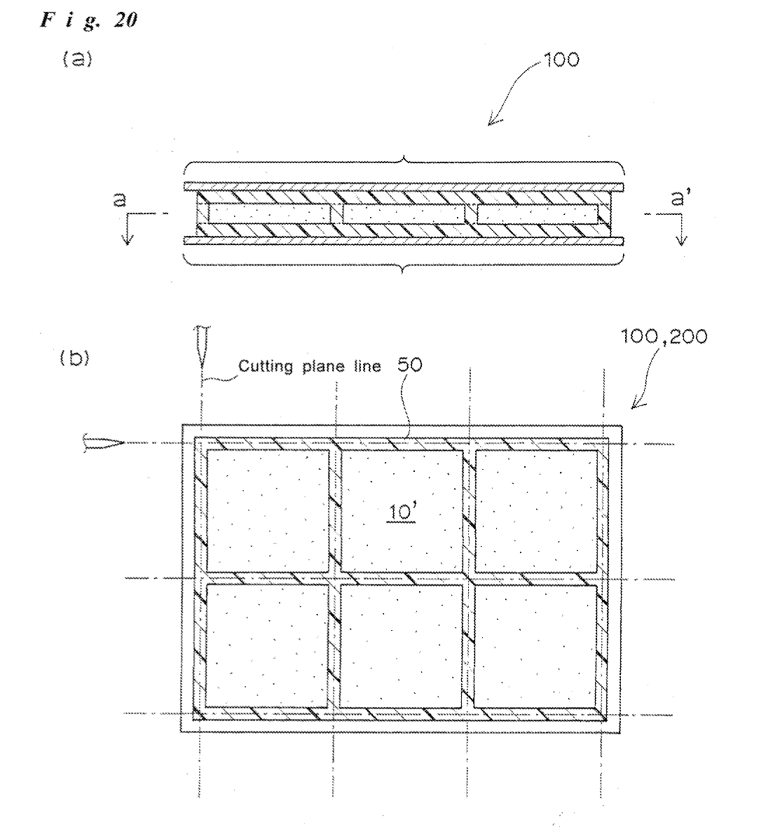

In the case where the frame member is used, an additional step for cutting the hybrid substrate 100 or the build-up substrate 200 using the same may be performed as shown in FIG. 20. In other words, the cutting of the substrate may be performed along the framing portion (solid portion) of the frame member to provide a singulated substrate 300 therefrom.

Although a few embodiments of the present invention have been hereinbefore described, they are merely illustrative especially with respect to tile arrangement. It will be readily appreciated by those skilled in the art that additional modifications and other alternative embodiments are possible without departing from the scope of the present invention.

For example, there can be obtained a build-up substrate with its higher density when a build-up resin layer and a copper wiring layer are further alternately built-up on one surface or both surfaces of the hybrid substrate. Especially, there can be obtained a build-up substrate with its higher density for a semiconductor integrated circuit package (and consequently semiconductor integrated circuit package can be obtained) from the hybrid substrate of the present invention. Specific embodiment regarding this is as follows:

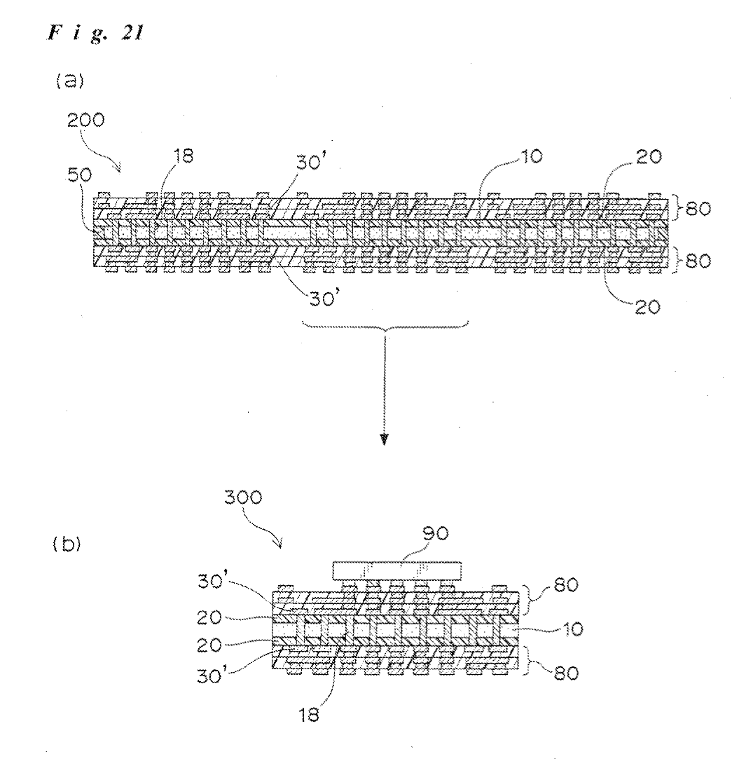

A build-up resin layer and a copper foil (from which wiring layer is formed) are laminated on both surfaces of the hybrid substrate, followed by being subjected to a thermosetting process. As a material of the build-up resin layer, thermosetting resins such as an epoxy resin and a phenol resin can be used. As the copper foil, an electrolytic copper foil having a thickness of about 2 μm to about 12 μm is used. Subsequently, the holes with diameter of about 70 μm to about 150 μm are formed at desired positions of the build-up resin layer through the copper foil by means of a carbon dioxide laser. Thereafter, a via-hole connection is formed by performing a desmearing treatment, a catalyst-adding treatment, an electroless copper plating treatment and an electrolytic copper plating treatment. Finally, the copper plated layer is subjected to an etching treatment using a photolithography process, and thereby a build-up wiring layer is formed. The hybrid substrate with the build-up layer formed thereon is cut into pieces at the portion of the frame member, and thereby a singulated hybrid substrate 200 can be obtained as shown in FIG. 21(a). Finally, the singulated hybrid substrate is further singulated to have the size of the semiconductor integrated circuit package, and thereby the build-up substrate for the semiconductor integrated circuit package is provided. Furthermore, when the semiconductor bare chip is mounted on the build-up substrate for the semiconductor integrated circuit package by a solder connection mounting process, a semiconductor integrated circuit package 300 as shown in FIG. 21(b) can be obtained.

The obtained semiconductor integrated circuit package 300 exhibits an extremely stable connection reliability against various heat histories and reliability tests. Particularly, the package has a desired stress relaxation characteristic and thus it exhibits a preventing effect of the delamination or the like. Further, the build-up substrate, which is composed of the hybrid substrate including the ceramic substrate and the reinforcing material, exhibits a less warp characteristic (substrate's warp per se being attributed to the heat history of the substrate), making it possible to extremely stabilize the reliability of the mounting connection between the semiconductor integrated circuit and the solder bump. Furthermore, such build-up substrate and package have a desired characteristic from the viewpoint of productivity. This is because the hybrid substrate of the present invention is constituted from the plurality of ceramics. That is, as compared with the case where build-up by build-up resin layer and wiring layer and mounting of semiconductor bare chip are performed per one ceramic substrate, the present invention can perform them collectively, and thereby an improved productivity is provided.

### EXAMPLES

### (Test for Fabrication of Hybrid Substrate)

In accordance with the present invention, a hybrid substrate was fabricated. Specifically, in accordance with process as shown in FIGS. 18 to 19, six ceramic substrates were disposed in the form of a tile arrangement to fabricate the hybrid substrate.

The fabricating conditions are as follows:

### Ceramic Substrate

Body: LTCC

Size of principal surface: 155 mm×156.5 mm

Number of tiles: 6

### Insulating Resin Layer

Body: material made from the prepreg of glass fiber and epoxy resin

Size of principal surface: 340 mm×510 mm

### Metal Layer

Body: copper foil

Size of principal surface: 370 mm×540 mm

### Frame Member

Body of framing portion: glass epoxy material

Size of hollow portion: 155 mm×156.5 mm

Number of hollow portions: 6

Inner frame width: 10 mm

Peripheral-outer frame width: 10 mm

It was confirmed that upsizing of the substrate can be really achieved by the present invention. In this regard, the resulting hybrid substrate had the following sizes:

### Hybrid Substrate

Total thickness: 535 μm

Size of principal surface: 370 mm×540 mm

### (Test for Application to Build-Up Substrate)

On both surfaces of the hybrid substrate, a build-up resin layer and a copper foil (from which wiring layer is formed) were laminated, followed by being subjected to a thermosetting process. As a material of the build-up resin layer, the prepreg having a sheet form (thickness: 50 μm) made of an epoxy resin was used. As the copper foil, an electrolytic copper foil having a thickness of about 12 μm was used. Subsequently, the holes with diameter of about 100 μm were formed at desired positions of the build-up resin layer as well as the copper foil by means of a carbon dioxide laser. Thereafter, a via-hole connection was formed by performing a desmearing treatment, a catalyst-adding treatment, an electroless copper plating treatment and an electrolytic copper plating treatment. Finally, the copper plated layer was subjected to an etching treatment using a photolithography process, and thereby a build-up wiring layer was formed. The hybrid substrate with the build-up layer formed thereon was cut into pieces at the portion of the frame member, and thereby a singulated hybrid substrate 200 was obtained (see FIG. 21(a)). Finally, the singulated hybrid substrate was further singulated to have the size of the semiconductor integrated circuit package, and thereby the build-up substrate for the semiconductor integrated circuit package was obtained. Furthermore, the semiconductor bare chip was mounted on the build-up substrate for the semiconductor integrated circuit package by a solder connection mounting process. As a result, a semiconductor integrated circuit package 300 was obtained (see FIG. 21(b)).

The obtained semiconductor integrated circuit package 300 exhibited an extremely stable connection reliability against various heat histories and reliability tests. Particularly, the package had a desired stress relaxation characteristic and consequently there was no occurred an adverse phenomenon such as the delamination or the like. Further, there was less warp in the build-up substrate, and there was prevented the warp attributed to the heat history, and consequently the reliability of the mounting connection between the semiconductor integrated circuit and the solder bump was extremely stabilized.

It should be noted that the present invention as described above includes the following aspects:

The first aspect: A hybrid substrate comprising:

a ceramic substrate assembly composed of a plurality of ceramic substrates (e.g., ceramic multilayer substrates);

insulating resin layers disposed respectively on both surfaces of the ceramic substrate assembly such that they are opposed to each other, each of the insulating resin layers being made at least of a reinforcing material and a resin; and

a metal layer disposed on each of the insulating resin layers,

and wherein the plurality of ceramic substrates are in the form of a tile arrangement (planar arrangement) along the same plane between the opposed insulating resin layers.

The second aspect: The hybrid substrate according to the first aspect, wherein the plurality of ceramic substrates are spaced from each other.

The third aspect: The hybrid substrate according to the second aspect, wherein a frame member (frame part) is provided between the opposed insulating resin layers; and

the plurality of ceramic substrates are in fit engagement with the frame member such that the substrate are located within the frame member, and thereby they are spaced from each other.

The fourth aspect: The hybrid substrate according to the first aspect, wherein the plurality of ceramic substrates are in close contact with each other.

The fifth aspect: The hybrid substrate according to any one of the first to fourth aspects, an inner via is provided in at least one of the plurality of ceramic substrates.

The sixth aspect: The hybrid substrate according to the fifth aspect, wherein at lease two of the plurality of ceramic substrates respectively have the inner via therein; and

said at least two ceramic substrates have a different configuration of the inner via from each other.

The seventh aspect: The hybrid substrate according to any one of the first to sixth aspects, wherein at least one wiring layer is provided in the interior or on the surface of at least one of the plurality of ceramic substrates.

The eighth aspect: The hybrid substrate according to the seventh aspect, wherein at lease two of the plurality of ceramic substrates respectively have the wiring layer therein; and said at least two ceramic substrates are different from each other in number or form of their wiring layers.

The ninth aspect: A method for producing a hybrid substrate comprising a ceramic substrate assembly, a metal layer and an insulating resin layer which is made at least of a reinforcing material and a resin, the method comprising the steps of:

(i) disposing a first insulating resin layer precursor on a first metal foil;

(ii) disposing a ceramic substrate assembly composed of a plurality of ceramic substrates on the first insulating resin layer precursor;

(iii) disposing a second insulating resin layer precursor on the ceramic substrate assembly, and then disposing a second metal foil on the second insulating resin layer precursor, and thereby forming a hybrid substrate precursor; and

(iv) pressing the hybrid substrate precursor under a heating condition to produce a hybrid substrate, and

wherein, in the step (ii), the plurality of ceramic substrates are disposed in the form of a tile arrangement (planar arrangement) such that the ceramic substrates are laid along the same plane.

The tenth aspect: The method according to the ninth aspect, wherein the plurality of ceramic substrates are disposed in spaced relation to each other when forming the tile arrangement of the ceramic substrates.

The eleventh aspect: The method according to the tenth aspect, wherein a frame member is used for the tile arrangement of the ceramic substrates, wherein the plurality of ceramic substrates are positioned in spaced relation to each other by fitting them respectively into the hollow portions of the frame member, and thereby the plurality of ceramic substrates are spaced from each other.

The twelfth aspect: The method according to the ninth aspect, wherein the plurality of ceramic substrates are disposed in close contact with each other when forming the tile arrangement of the ceramic substrates.

### INDUSTRIAL APPLICABILITY

The hybrid substrate of the present invention can be suitably used not only as a substrate for a radio RF module of a mobile device and a power LED in which heat radiation is considered, but also as a substrate for an LED backlight of a liquid crystal. The hybrid substrate of the present invention can also be suitably used as a substrate of an electronic equipment on which electronic components are mounted with a high density.

In particular, the hybrid substrate according to the present invention can be suitably used for the production of a build-up substrate since it has large size. Therefore, it is useful as a substrate for a semiconductor package where a CPU semiconductor integrated circuit of a computer, a server or the like is mounted on the substrate.

### CROSS REFERENCE TO RELATED PATENT APPLICATION

The present application claims the right of priority of Japan patent application No. 2010-120026 (filing date: May 26, 2010, title of the invention: HYBRID SUBSTRATE), the whole contents of which are incorporated herein by reference.

### EXPLANATION OF REFERENCE NUMERALS

10: Ceramic substrate assembly

10: Ceramic substrate

18: Inner via

19: Wiring layer

20: Insulating resin layer

20A: First insulating resin layer precursor

20B: Second insulating resin layer precursor

22: Glass cloth

24: Thermosetting resin liquid

30: Metal layer

30: Build-up wiring layer

30A: First metal foil

30B: Second metal foil

50: Frame member

50: Hollow portion of frame member

60: Pressing parts

61: Metal plate (for example, SUS plate)

62: Elastic plate (for example, rubber plate)

70: Chamber

80: Build-up layer

90: Semiconductor bare chip

100: Hybrid substrate precursor

100: Hybrid substrate

200: Build-up substrate (Singulated substrate)

300: Build-up substrate (Semiconductor integrated circuit package) obtained through dividing the substrate into pieces for singulation.

What is claimed is:

1. A hybrid substrate comprising:
a ceramic substrate assembly composed of a plurality of ceramic substrates;
insulating resin layers disposed respectively on both surfaces of the ceramic substrate assembly such that they are opposed to each other, each of the insulating resin layers being made at least of a reinforcing material and a resin; and
a metal layer disposed on each of the insulating resin layers,
and wherein the plurality of ceramic substrates are in the form of a tile arrangement along the same plane positioned between the opposed insulating resin layers.

2. The hybrid substrate according to claim 1, wherein the plurality of ceramic substrates are spaced from each other.

3. The hybrid substrate according to claim 2, wherein a frame member is provided between the opposed insulating resin layers; and
the plurality of ceramic substrates are fitted into the frame member so that they are spaced from each other.

4. The hybrid substrate according to claim 1, wherein the plurality of ceramic substrates are in close contact with each other.

5. The hybrid substrate according to claim 1, wherein at least one of the plurality of ceramic substrates has an inner via therein.

6. The hybrid substrate according to claim 5, wherein at lease two of the plurality of ceramic substrates respectively have the inner via therein; and
said at least two ceramic substrates are different from each other in configuration of their inner vias.

7. The hybrid substrate according to claim 1, wherein at least one of the plurality of ceramic substrates has at least one wiring layer in the interior thereof or on the surface thereof.

8. The hybrid substrate according to claim 7, wherein at lease two of the plurality of ceramic substrates respectively have the wiring layer therein; and
said at least two ceramic substrates are different from each other in number or form of their wiring layers.

9. A method for producing a hybrid substrate comprising a ceramic substrate assembly, a metal layer and an insulating resin layer which is made at least of a reinforcing material and a resin, the method comprising the steps of:
(i) disposing a first insulating resin layer precursor on a first metal foil;
(ii) disposing a ceramic substrate assembly composed of a plurality of ceramic substrates on the first insulating resin layer precursor;
(iii) disposing a second insulating resin layer precursor on the ceramic substrate assembly, and then disposing a second metal foil on the second insulating resin layer precursor, and thereby forming a hybrid substrate precursor; and
(iv) pressing the hybrid substrate precursor under a heating condition to produce a hybrid substrate, and
wherein, in the step (ii), the plurality of ceramic substrates are disposed in the form of a tile arrangement such that they are laid along the same plane.

10. The method according to claim 9, wherein the plurality of ceramic substrates are disposed in spaced relation to each other so that the tile arrangement of the ceramic substrates is formed.

11. The method according to claim 10, wherein a frame member is used for the tile arrangement of the ceramic substrates, wherein the plurality of ceramic substrates are disposed in spaced relation to each other by fitting them respectively into the hollow portions of the frame member.

12. The method according to claim 9, wherein the plurality of ceramic substrates are disposed in close contact with each other so that the tile arrangement of the ceramic substrates is formed.
